(19) United States
(12) Patent Application Publication
(10) Pub. No.: US 2007/0080003 A1
(43) Pub. Date: Apr. 12, 2007

(54) Mode selection for wheelchairs

(75) Inventors: James M. Koerlin, Broomfield, CO (US); Wayne T. Mansell, Stourbridge (GB)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignee: Sunrise Medical HHG, Inc.

(21) Appl. No.: 11/545,907

(22) Filed: Oct. 11, 2006

Related U.S. Application Data
(60) Provisional application No. 60/725,260, filed on Oct. 11, 2005.

(51) Int. Cl. B60K 1/00

(52) U.S. Cl. 180/65.1; 180/907

(57) ABSTRACT

A method and apparatus for navigating to operating modes or functions.

### CROSS REFERENCE TO RELATED APPLICATIONS

This application claims the benefit of U.S. Provisional Patent Application No. 60/725,260, filed on Oct. 11, 2005.

### BACKGROUND OF INVENTION

The present invention is generally related to land vehicles, and more particularly related to personal mobility vehicles. Most particularly, the invention is related to mode selection for wheelchairs.

Mode selection of a wheelchair is typically accomplished by depressing a mode button, and navigating left and right along a function selection display.

What is needed is an easier manner in which a wheelchair user can select operating modes or functions.

### SUMMARY OF INVENTION

The present invention is directed toward the provision of wheelchair mode selection whereby operating modes or functions may be selected by simply selecting a mode or function group and then selecting a mode or function within that group.

### DESCRIPTION OF THE DRAWINGS

FIG. 1 is a side elevational view of an exemplary power wheelchair.

FIG. 2 is a diagrammatic representation of an exemplary motor controller.

FIG. 3 is a top plan view of an exemplary user interface device.

FIG. 4 is a top plan view of an exemplary drive profile indicator.

FIG. 5 is a top plan view of an exemplary seating function indicator.

FIG. 6 is a top plan view of an exemplary battery state of charge (BSOC) indicator.

### BRIEF DESCRIPTION OF THE INVENTION

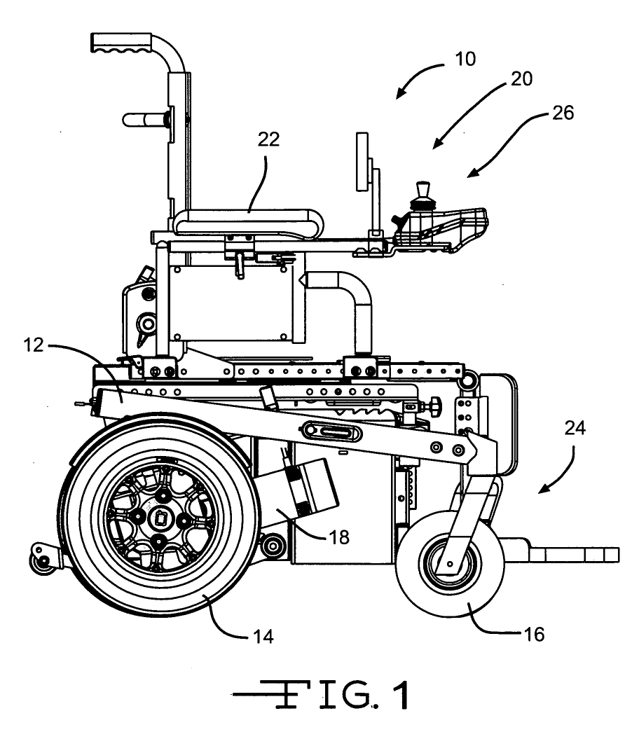

Referring now to the drawings, there is illustrated in FIG. 1 an exemplary power wheelchair, generally indicated at 10, which represents one of many wheelchairs, or other light transport vehicle (e.g., scooter), configurations with which the invention may be practiced. The exemplary wheelchair 10 may comprise a chassis, which may be inclusive of a frame 12, and which may be supported for movement in relation to a supporting surface (i.e., the floor or the ground) by one or more ground engaging wheels, such as the driven wheels 14 and the non-driven caster wheels 16 shown. The driven wheels 14 may be respectively driven by left and right power train or drive units mounting the driven wheels 14 to the chassis or frame 12. Each drive unit may include a drive motor 18, as shown, and associated gear train and transmission unit (not shown).

The chassis is dimensioned and configured to support various wheelchair components, such as but not limited to a battery tray (not shown) for supporting one or more batteries for providing power to the wheelchair 10, a wiring assembly for supplying power to, and for providing communication between, various electronic components of a control system and optional electronics, and a seat assembly 20 for supporting a wheelchair occupant. The seat assembly 20 may be of the type that tilts and/or lifts and reclines, and preferably has opposing armrests 22 for supporting the wheelchair occupant's arms and leg rests 24 for supporting the wheelchair occupant's legs. The armrests 22 may support for attachment one or more user interface devices 26, such as a hand control and a control display, which may include one or more LED and/or liquid crystal displays. The various electronic components may include a motor control module for controlling the driven motors 18 and various other general functions of the wheelchair 10, a specialty control module for controlling switch-type inputs (e.g., Sip-and-Puff, ASL, Switch-It and Tash discrete switches, and a head control), a multi actuator control (MAC) module for controlling one or more actuators (e.g., seat tilt, shear, lift and recline actuators and largest actuators), and an environmental control module (ECM) for interfacing with environmental devices, including but not limited to infrared devices, radio frequency devices, or other wireless devices, including but not limited to those using Bluetooth ® technology, of Bellevue, Wash., USA.

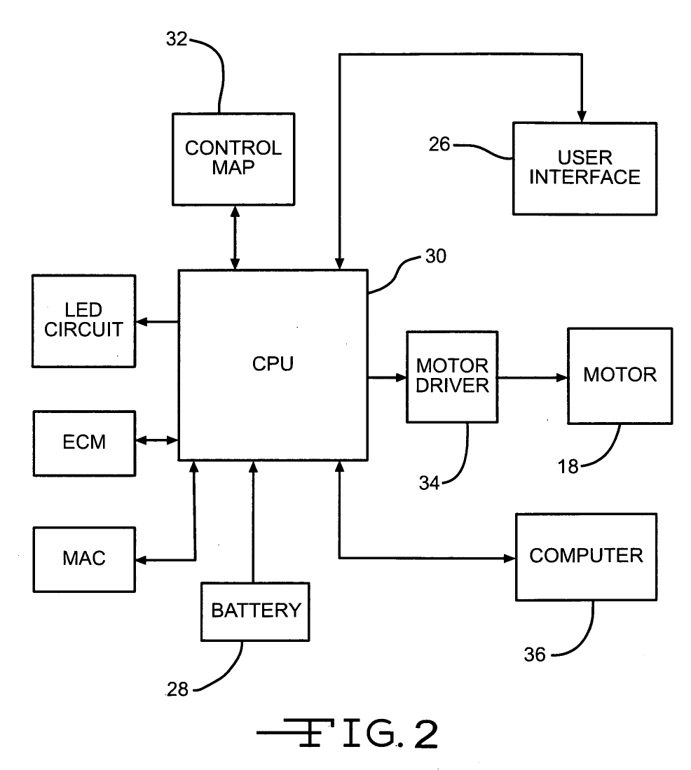

FIG. 2 shows components of the motor control module and the data passing between the components. The exemplary motor control module may be connected to the MAC, the ECM, the motor 18, the user interface 26 and a battery 28, and may comprise a central processing unit (CPU) 30, a control map 32, a motor driver 34, and associated circuitry, which may be encased in an enclosure mounted on the chassis or frame 12. Alternatively, components and circuitry for the motor control module may be housed in a control box (not shown) that is integral with the drive unit/gear box.

The motor control module operates through the CPU 30, which may be implemented as a programmable microprocessor. The motor control module may utilize the control map 32 for a desired dynamic, or drive profile. The desired dynamic may be programmed into the CPU 30 and may be specifically configured to meet the needs of the individual user. The CPU 30 may be programmable through the use of a PC-based computer 36, or handheld programmer, having associated memory storage. Resident on the computer 36 may be a design tool, such as PC setup station (PCSS) software, for specifying and downloading these control maps 32 to the CPU 30. The PCSS may offer different functionality based on the user group (user, service, dealer, OEM). An infrared link (or other wireless communication) may facilitate data transfer between the CPU 30 and the external computer 36. Alternatively, the CPU 30 and the external computer 36 may be physically connected.

The various control maps 32 for various drive profiles, with the same or different torque settings, may be accessed by the user through the use of the interface 26 between the user and the CPU 30. The interface 26 may be provided with a switch or button, such as a mode button, as will be described in greater detail below, that allows the user to select between the various control maps 32 pre-programmed into the CPU 30. The display may be used to indicate which control map 32 or drive profile has been selected by the user. Once the user selects the desired control map 32, the CPU 30 may compute the desired system output or control signal for controlling the motor 18.

The motor control module may operate to provide a control signal to the motor 18 as follows. The CPU 30 may accept a command input from the interface 26, and in response, may output a control signal to the motor 18 via the motor driver 34. The control signal contains magnitude and polarity information which may be presented to the motor driver 34 to produce an appropriate motor output. The motor driver 34 may convert the control signal into a voltage of appropriate magnitude and polarity to be applied to the motor 18. The magnitude and polarity of the voltage corresponds to the speed and direction in which the motor 18 is operated.

In FIG. 3, there is illustrated an example of a user interface device 26, which represents one of many user interface devices with which the invention may be practiced. The exemplary user interface device 26 is in the form of a seven-button hand control, which may include a joystick 38 (or other directional input) and one or more buttons, including but not limited to an on/off button 40, a mode button 42 (or other suitable mode selection input), and buttons for hazard lights, head lights, left and right turn signals, a horn, and speed control. The user interface device 26 may also include software assignable buttons. One or more switches and knobs, such as an on/off or mode switch (e.g., in lieu of the on/off or mode button) or a speed control knob, may also be provided. Moreover, the user interface device 26 may include control displays, including but not limited to a battery state of charge (BSOC) indicator 44, a drive profile icon or indicator 46, and a seating function icon or indicator 48, as shown, by example, in the drawings. The description that follows will refer to the mode button 40 and joystick toggle directions or commands, such as the forward, reverse, left and right toggle directions shown. Similar toggle directions or commands may be achieved with other inputs (e.g., switches or buttons).

The user interface device 26 may operate as follows. The power button 40 may be provided for turning on and off the power wheelchair 10. When the wheelchair 10 is turned on, lights may become visible on the user interface device 26 and an acoustical output may provide feedback to the user to indicate that the wheelchair 10 is ready to drive. The drive profile indicator 46 may indicate the current drive profile. The mode button 40 may be used to change drive profiles. The mode button 40 may also be used for controlling other wheelchair functions, such as the functions of the MAC module and the ECM, based on the modules installed on the wheelchair 10.

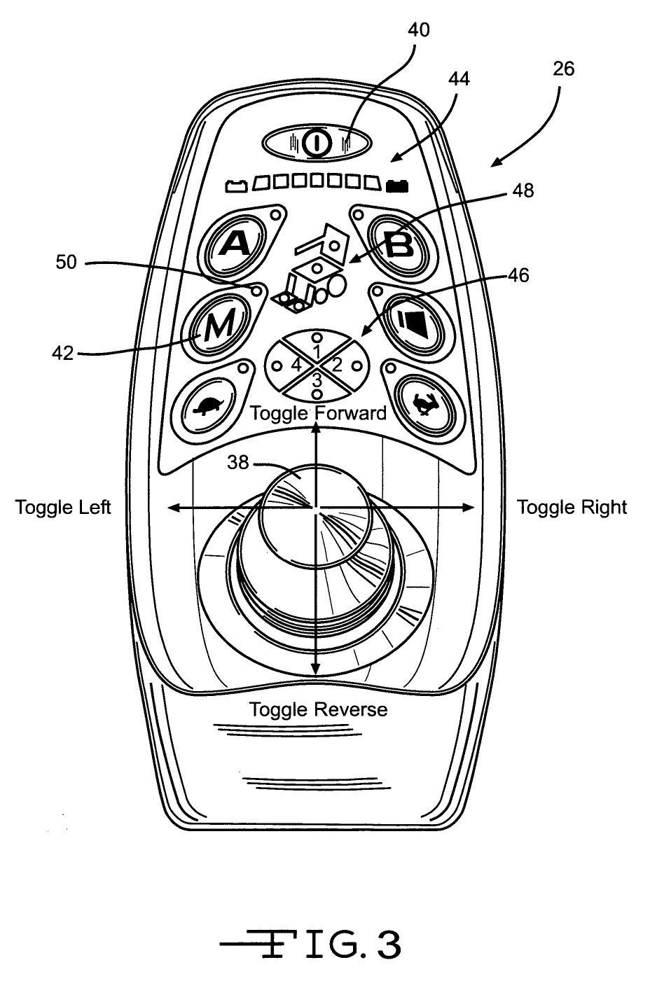

Upon depressing the mode button 40 once, a mode selection light 50 (e.g., an LED or other suitable light) near the mode button 40 may illuminate a predetermined color, for example, red, to indicate that the drive profile selection mode has been selected. In this mode, the joystick 38 may be used to select a desired drive profile. For example, by moving the joystick 38, preferably all the way, forward, the user may select a first drive profile (e.g., Drive Profile 1). The joystick 38 may be moved, preferably all the way, right to select a second drive profile (e.g., Drive Profile 2), in reverse to select a third drive profile (e.g., Drive Profile 3), and left to select a fourth drive profile (e.g., Drive Profile 4). When the user has selected a desired drive profile, a drive profile light 52 (e.g., an LED or other suitable light) (see FIG. 4) on the drive profile indicator 46 for that drive profile may illuminate to indicate that it is that drive profile that has been selected. The drive profile lights 52 are preferably red in color, like the mode selection light 50. After the user has selected a desired drive profile, the control system may automatically return to a drive mode, wherein any further movement of the joystick 38 will begin to move the wheelchair 10.

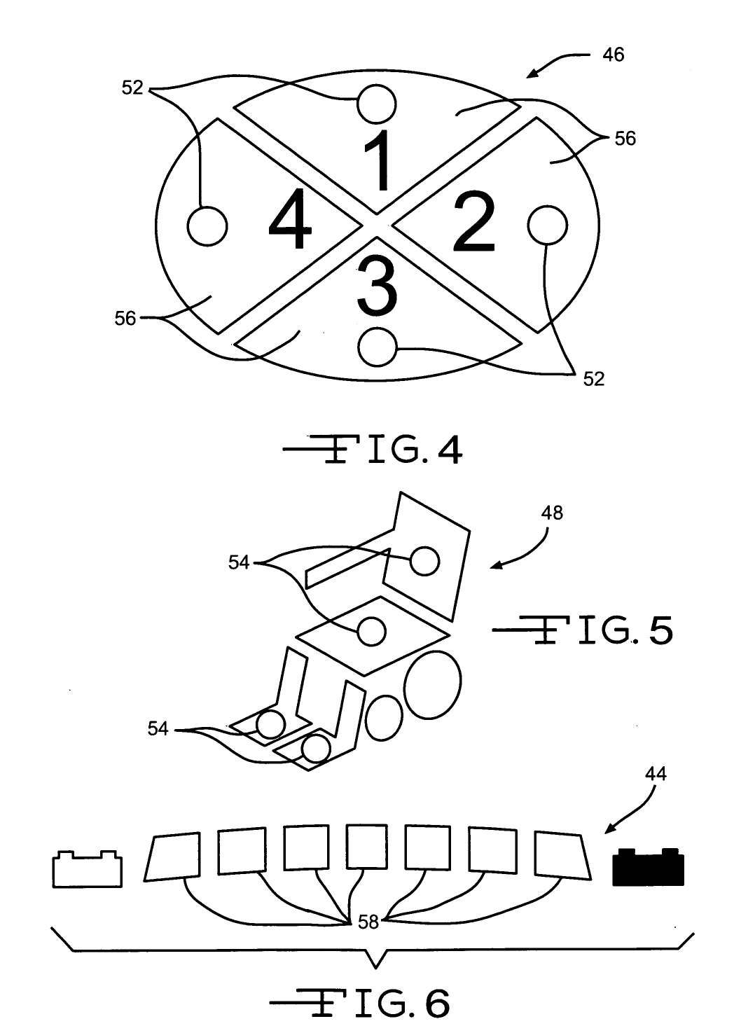

If the wheelchair 10 has seating functions, the user may depress the mode button 40 twice to enter a seating control mode. The mode selection light 50 by the mode button 40 may be illuminate in a different color, for example, green, to indicate that the seating mode has been selected. In the seating mode, lights 54 (e.g., LEDs or other suitable lights) (see FIG. 5) on the seating function indicator 48 may illuminate to indicate which seating actuator (e.g., seat tilt, shear, lift and recline actuators and leg rest actuators) has been selected. The joystick 38 may be used to select seating actuators. For example, different seating actuators may be selected by moving the joystick 38 left or right. While any of the seating actuators is selected, moving the joystick 38, for example, forward or reverse will move the actuator in one direction or the other.

If the mode button 40 is depressed three times (or twice if the wheelchair 10 has no seating functions), the control will change into an environmental control mode and the mode selection light 50 next to the mode button 40 may light up in yet a different color, for example, amber.

Depressing the mode button 40 may cycle the control system from drive to drive profile selection mode to seating control mode to environmental control mode and then back to drive in sequence. If the wheelchair 10 is not equipped with seating functions or environmental functions, then the control system may automatically skip these modes as the mode button 40 is selected in sequence. This may also occur if only one of the four possible drive profiles is active or provided. The drive profile indicator 46 and the seating function indicator 48 may provide real-time feedback about the wheelchair operation to allow the user to more easily gauge the operation of the wheelchair 10.

As shown in FIG. 4, the exemplary drive profile indicator 46 is in the form of a pie chart, which represents one of many drive profile indicators with which the invention may be practiced. The pie chart is a graphic representation of a circle divided or segmented into sections 56 represented as “slices” of a pie. In the illustrated embodiment, the pie chart is divided into four sections 56. These sections 56 may be associated with the four aforementioned joystick toggle directions forming a cross command pattern. When a selection is made, the light 52 associated with that section 56 becomes illuminated to confirm the selection (e.g., 1, 2, 3 and 4).

It should be appreciated that the drive profile indicator 46 may take on a form or shape other than that shown and described. That is, a shape other than the circle shown may be used. It should also be appreciated that fewer or more than four sections may be provided. Moreover, a command pattern other than the cross command pattern shown may be used. For example, a diagonal command pattern could be used alone or in combination with the cross command pattern described above. If used in combination, for example, eight sections may be provided.

The control system allows a power wheelchair user to make selections from a simple visual indicator. In summary, a mode or function may be selected by depressing the mode button 40 (or the provision of any other suitable input). A single depression of the mode button 40 may cause the mode selection light 50 to illuminate a first color, a second depression of the mode button 40 may cause the mode selection light 50 to illuminate a second color, and so on. That is to say, each time the mode button 40 is depressed, the mode selection light 50 may illuminate a different color. The color of the mode selection light 50 may correspond to the mode or function selected. A different mode or function may be selected with a navigation command (e.g., via a joystick 38 or buttons).

The colored lights described above are not limited to provide a status indication. The lights may also be used to report errors from different modes and/or functions, such as an error occurring in the performance of a function, like an actuator extending beyond a certain threshold, or to indicate another error condition or latched state. The lights may flash on and off or otherwise provide a conspicuous indication that an error has occurred.

Alternatively, the BSOC indicator 44 may be used to report errors. As shown in FIG. 6, the BSOC indicator 44 may include one or more lights (e.g., LEDS) 58, which may illuminate in one or more colors (e.g., red, green, amber, etc.). For example, when the lights 58 are a solid and steady green color, the battery may have a high state of charge. When the lights 58 are an amber color, the battery may not be highly charged, but may still be charged to some extent. When the lights 58 are only red in color, the battery charge is low, and the wheelchair user should be careful not to run out of battery charge or the wheelchair 10 will no longer operate.

If the lights 58 flash, then the BSOC indicator 44 may indicate a fault. Diagnostic or fault information may be displayed by a sequence and/or combination of the lights 58 in predetermined color. The sequence and/or combination of flashing lights 58 and colors (e.g., red, green, amber, etc.) may correspond to diagnostic codes indicative of a fault occurring. If multiple faults exist, the BSOC indicator 44 may display a sequence and/or combination of flashing lights 58 and colors representing the highest level fault. If a fault occurs in a particular mode, the fault display may be extinguished by changing from one mode to another. For non-critical faults, the BSOC indicator 44 may alternate between the battery charge display and the fault display.

Diagnostic codes may be provided to the wheelchair user, for example, in the form of a table listing, for example, light illumination state (e.g., red, green, amber, etc.), error description (e.g., motor controller internal error, loss of communication error, etc.), and the fault priority (e.g., 1-10). For example, if one light 58 is flashing red, two lights 58 are flashing amber, and four lights 58 are flashing green, a motor controller internal module error may be TRUE. Such a fault may have a priority of 2 on a scale of 1 to 10. To receive a fault indication, it should be noted that the user need not first depress the mode button 40 (or the provision of any other suitable input) and then navigate to a particular mode or function with a separate navigational input (e.g., the joystick 38 or buttons).

The principle and mode of operation of this invention have been explained and illustrated in its preferred embodiment. However, it must be understood that this invention may be practiced otherwise than as specifically explained and illustrated without departing from its spirit or scope.

What is claimed is:

1. A wheelchair comprising:
a user interface device having a mode selection input and one or more directional inputs; and
one or more visual indicators each representing a mode or function group corresponding to a mode or function of the wheelchair, each mode or function having one or more lights each representing an operating mode or function, input from the mode selection input selects a mode or function group, input from the directional input navigates to an operating mode or function.

2. A method for selecting modes or function of a wheelchair, comprising the steps of navigating to an operating mode or function, comprising the steps of:
a) selecting a function group; and
b) selecting a function within that group.
